(19) United States
(12) Patent Application Publication
(10) Pub. No.: US 2023/0306116 A1
(43) Pub. Date: Sep. 28, 2023

(54) RULES MODIFICATIONS

(71) Applicant: Hewlett-Packard Development Company, L.P., Spring, TX (US)

(72) Inventors: Remy HUSSON, Bristol (GB); Yelena Helen BALINSKY, Bristol (GB); Jose Luis Abad PEIRO, Sant Cugat del Valles (ES)

(73) Assignee: Hewlett-Packard Development Company, L.P., Spring, TX (US)

(21) Appl. No.: 17/704,899

(22) Filed: Mar. 25, 2022

(51) Int. Cl. G06F 21/57

(52) U.S. Cl. CPC G06F 21/57; G06F 2221/034

(57) ABSTRACT

According to examples, an apparatus includes a processor that is to receive a transaction for a smart contract on a blockchain to progress a state of a workflow instance of the smart contract. The processor is to identify a rule correlated to the received transaction among a set of rules for the smart contract and is to load the identified rule correlated to the received transaction into the smart contract. The processor is to determine whether the received transaction is valid based on application of the identified rule in the smart contract. Based on a determination that the received transaction is valid based on application of the identified rule, the processor is to progress the state of the workflow instance of the smart contract.

### BACKGROUND

A blockchain generally stores information in a manner that provides fidelity and security of data records. As a result, blockchains often generate trust without a need for a trusted third party. Application programs, such as smart contracts, may be implemented in blockchains to leverage the security aspects of the blockchains. In some instances, smart contracts on the blockchains need to be updated, for instance to update rules for the smart contract.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an example apparatus that is to load a rule correlated to a transaction for a smart contract from among a set of rules, and to progress a state of the smart contract based on application of the loaded rule;

FIG. 2 depicts a block diagram of an example system that includes the example apparatus depicted in FIG. 1;

FIG. 3 depicts a flow diagram of an example workflow instance of the smart contract depicted in FIG. 2;

FIG. 4 depicts a diagram of an example rules matrix that includes a set of rules for the workflow instance depicted in FIG. 3;

FIG. 5A depicts diagrams of an example version control, in which the example workflow instance depicted in FIG. 3 and the example rules matrix depicted in FIG. 4 are modified to create a modified workflow instance and a modified rules matrix in which a state in the workflow instance is modified;

FIG. 5B depicts diagrams of an example version control, in which the example workflow instance depicted in FIG. 3 and the example rules matrix depicted in FIG. 4 are modified to create a modified workflow instance and a modified rules matrix in which a new state in the workflow instance is created;

FIG. 6 depicts a diagram of an example bridge rules matrix that is to bridge the version of the workflow instance depicted in FIG. 3 to the second version of the workflow instance depicted in FIG. 5A;

FIG. 7 shows a flow diagram of an example method for deploying a smart contract, creating an initial rules matrix, modifying the rules matrix, and loading a rule from the initial rules matrix or the modified rules matrix to progress a state of the smart contract;

FIG. 8 depicts a block diagram of an example non-transitory computer-readable medium that has stored thereon computer-readable instructions to create a set of rules for a smart contract and to load a rule for a transaction from the set of rules to progress a state of a workflow instance of the smart contract; and

FIG. 9 depicts a block diagram of an example non-transitory computer-readable medium that has stored thereon computer-readable instructions to modify a set of rules for a smart contract and to load a modified rule for a transaction from the modified set of rules to progress a state of a workflow instance of the smart contract.

### DETAILED DESCRIPTION

Computing devices that are implemented to operate on a blockchain network securely store data in a data structure called a blockchain. A blockchain is a distributed set of data, for instance a distributed database, that is shared among the nodes of the blockchain network. The blockchain stores information in a growing list of records, called “blocks,” that are linked to together using a cryptographic hash. Each block contains a hash of the previous block together with the new transaction data. New information is compiled into a new block that is added to the chain of blocks. As such, blockchains are resistant to modification since the data in a particular block are not able to be altered retroactively without altering all subsequent blocks, which thus affords inherent security.

Secure industrial and business workflows are implemented through blockchain technology. For instance, smart contracts are implemented on a blockchain to enforce business rules. Smart contracts are computer programs, or sets of instructions, implemented on blockchains to automatically execute, control, or document legally relevant events and actions according to the terms of a contract or agreement. In some examples, smart contracts are represented as workflows of state machines. Workflows for smart contracts include a plurality of states, or steps, and rules that define conditions necessary to progress from one state to another.

A concern with smart contracts based on blockchain technology is that it is difficult to update the rules for the smart contracts because the rules are incorporated into the code for the smart contracts. For instance, the rules for smart contracts are often static, and often do not require frequent updates. However, in some implementations, the rules do require frequent updates or modifications. In these implementations, the update mechanisms to update the smart contracts are often heavy, for instance, requiring coordination of all participants to agree and deploy a new version. As such, in cases where a business workflow requires regular updates or modifications to the rules for the smart contracts, the heavy update mechanisms become bottlenecks. In other instances, modifications or updates to the rules at a certain point in time affect all other in-progress workflow instances, which could result in deadlock, compatibility issues, or a combination thereof, which results in delays and downtime.

Disclosed herein are apparatuses to implement smart contracts on blockchains, in which the smart contracts and the rules to be enforced in the smart contracts are stored separately on the blockchain. For instance, the rules for smart contracts are disposed in the blockchain, separate from the smart contract, and are to be retrieved by the smart contract for enforcement. In some examples, a rule correlated to a received transaction is to be identified among a set of rules for the smart contract and loaded into the smart contract. The smart contract is to apply the identified rule to the received transaction to determine whether the received transaction is valid, and is to progress the state of the workflow instance of the smart contract based on a determination that the received transaction is valid.

Through implementation of smart contracts and the rules to be enforced by the smart contracts to be stored separately on a blockchain as disclosed herein, improved updates to the rules for the smart contracts are facilitated. For instance, modifications of rules for the smart contracts are possible without the overhead for updating/recompiling the smart contracts. The modifications of the rules for the smart contracts, without the need to modify the smart contract as discussed herein, results in reductions in certain amounts of computing resources and time, which are otherwise needed to update the smart contracts for rule modifications and updates.

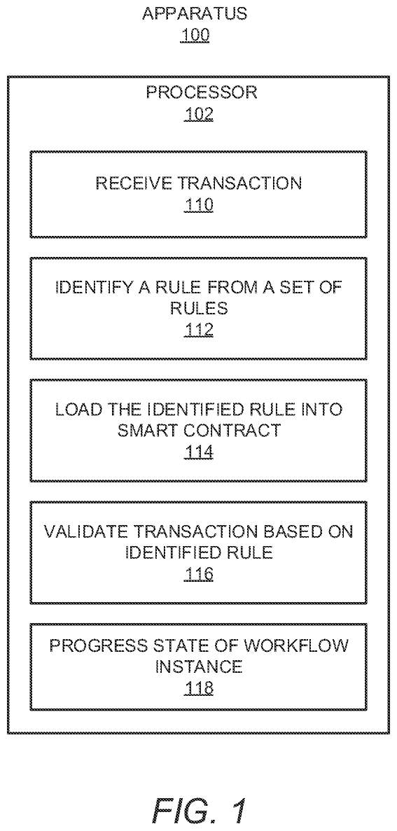

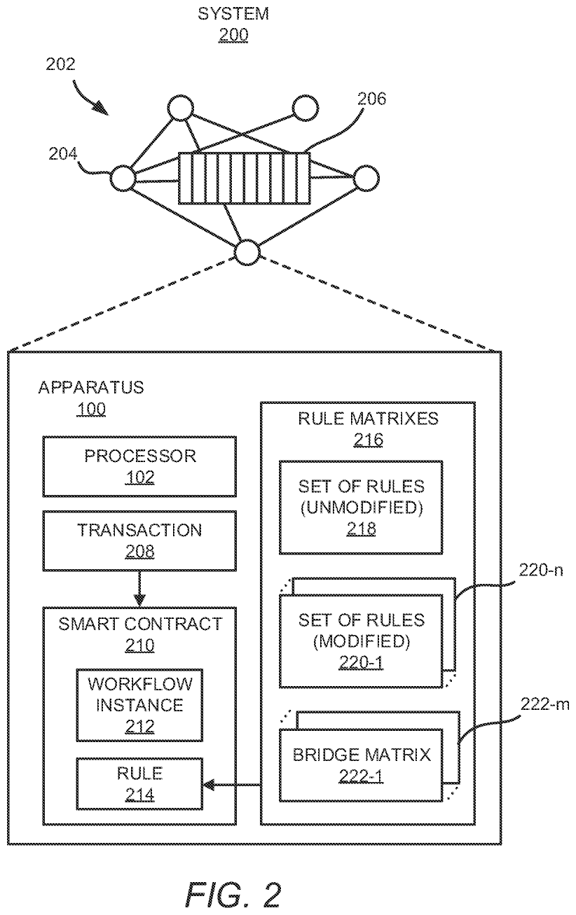

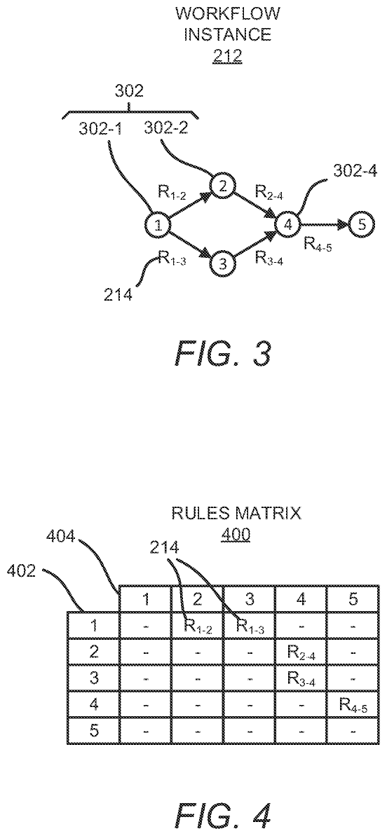

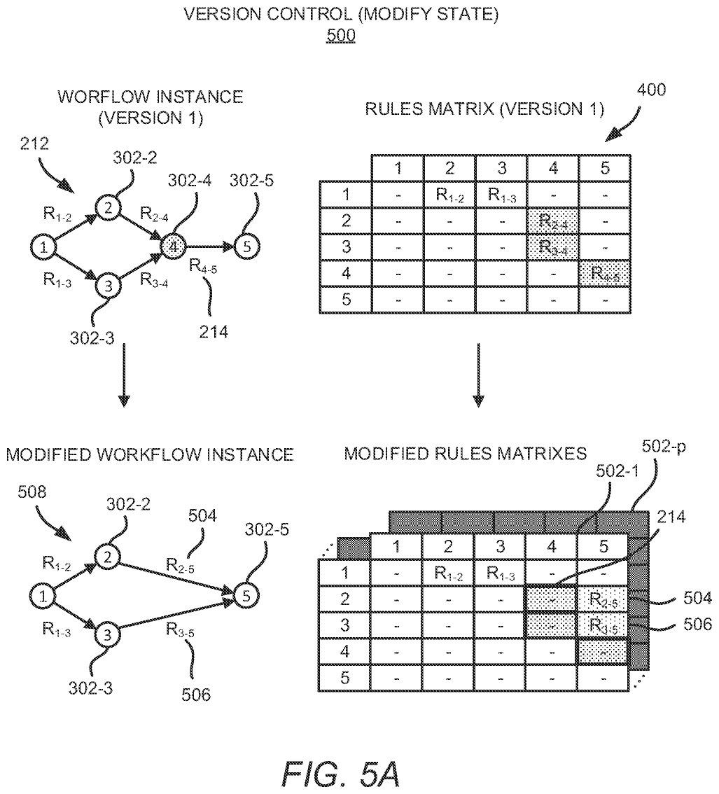

Reference is made to FIGS. 1, 2, 3, 4, 5A, 5B, and 6. FIG. 1 depicts a block diagram of an example apparatus 100 that loads a rule correlated to a transaction for a smart contract from among a set of rules, and progresses a state of the smart contract based on application of the loaded rule. FIG. 2 shows a block diagram of an example system 200 that includes the example apparatus 100 depicted in FIG. 1. FIG. 3 depicts a flow diagram of an example workflow instance 300 of the smart contract depicted in FIG. 2, and FIG. 4 depicts a diagram of an example rules matrix 400 that includes a set of rules for the workflow instance 300 depicted in FIG. 3.

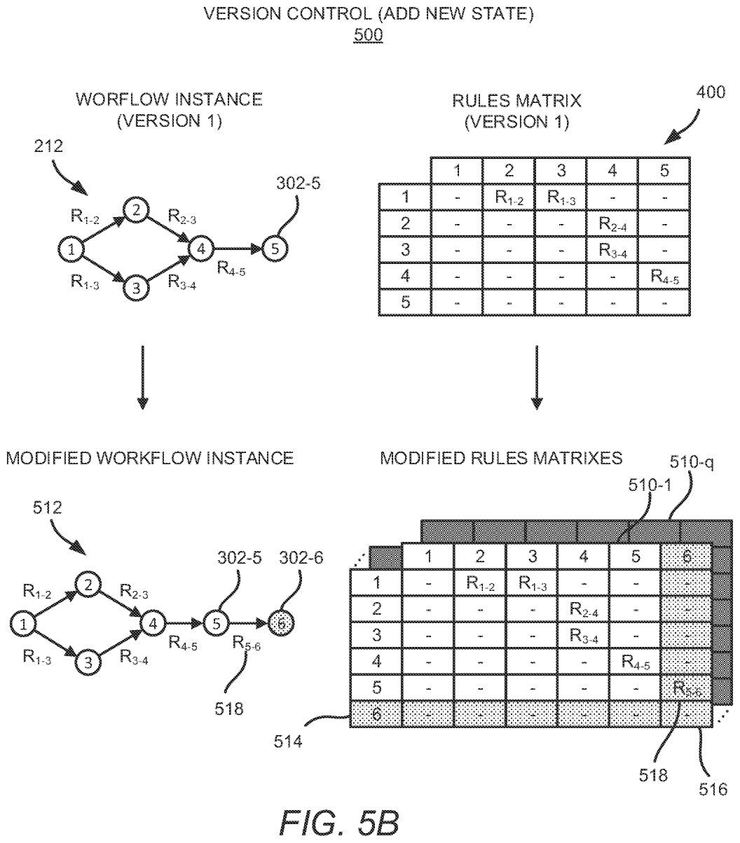

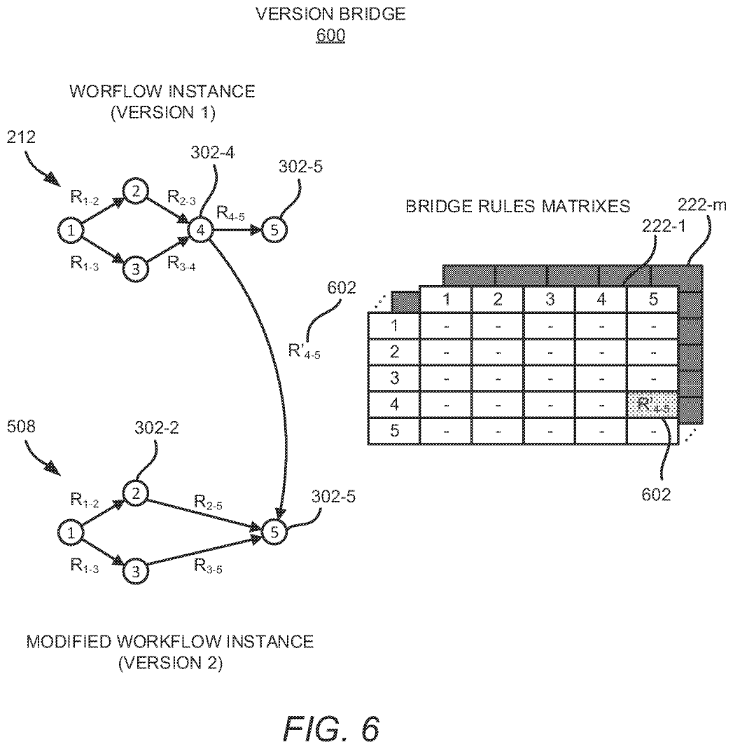

FIG. 5A depicts diagrams of an example version control 500, in which the example workflow instance depicted in FIG. 3 and the example rules matrix depicted in FIG. 4 are modified to create a modified workflow instance and a modified rules matrix in which a state in the workflow instance is modified. FIG. 5B depicts diagrams of the example version control 500, in which the example workflow instance 300 depicted in FIG. 3 and the example rules matrix 400 depicted in FIG. 4 are modified to create a modified workflow instance and a modified rules matrix in which a new state in the workflow instance is created. FIG. 6 depicts a diagram of an example version bridge 600, in which a bridge rules matrix is to bridge a version of the workflow instance 212 depicted in FIG. 3 to the modified workflow instance 508 depicted in FIG. 5A.

It should be understood that the apparatus 100 depicted in FIG. 1, the system 200 depicted in FIG. 2, the example workflow instance 300 depicted in FIG. 3, the example rules matrix 400 depicted in FIG. 4, the example version control 500 depicted in FIGS. 5A and 5B, and the example version bridge 600 depicted in FIG. 6 may include additional features and that some of the features described herein may be removed or modified without departing from the scopes of the apparatus 100, the system 200, the workflow instance 300, the rules matrix 400, the version control 500, and the version bridge 600.

The apparatus 100 includes a processor 102 and the apparatus 100 is be a server, a node in a network (such as a data center), a personal computer, a laptop computer, a tablet computer, a smartphone, a network gateway, a network router, an electronic device such as Internet of Things (IoT) device, or another appropriate type of computing device based on the intended implementation. The processor 102 is a semiconductor-based microprocessor, a central processing unit (CPU), an application specific integrated circuit (ASIC), a field-programmable gate array (FPGA), or other hardware device. Although the apparatus 100 is depicted as having a single processor 102, it should be understood that the apparatus 100 may include additional processors or cores without departing from a scope of the apparatus 100.

As shown in FIG. 1, the processor 102 is to perform operations 110-118 to execute smart contracts in blockchains. In some examples, the operations 110-118 are hardware logic blocks that the processor 102 is to execute. In other examples, the operations 110-118 are machine readable instructions, e.g., non-transitory computer readable instructions. The term “non-transitory” does not encompass transitory propagating signals. In other examples, the apparatus 100 includes a combination of instructions and hardware logic blocks to implement or execute functions corresponding to the operations 110-118.

The apparatus 100 is connected via a network 202, such as the Internet or a local area network, to a plurality of nodes 204. The network 202 is implemented as a blockchain network, which is a peer-to-peer network to manage a blockchain 206. The plurality of nodes 204 are participants of the blockchain network. The apparatus 100 is one of the plurality of nodes 204 on the network 202.

The processor 102 is to execute the operation 110 to receive a transaction 208 for a smart contract 210 on the blockchain 206. The received transaction 208 is a transaction to progress a state of a workflow instance 212 of the smart contract 210. The received transaction 208 is a blockchain transaction.

In some examples, the processor 102 is to create a workflow instance 212 for the smart contract 210, as depicted in FIG. 3, on the blockchain 206. The workflow instance 212 may be described as a state machine that includes predefined states 302, or steps, and a set of rules 218 correlated to the states 302. The set of rules 218 define the conditions necessary to progress the states 302 of the workflow instance 212. While FIG. 2 depicts a single set of rules 218, it should be understood that, in some examples, a plurality of sets of rules 218 are stored on the blockchain 206.

The processor 102 is to store the set of rules 218 on the blockchain 206, separate from the smart contract 210. The set of rules 218 includes a list of rules correlated to the workflow instance 212. In some examples, the processor 102 is to store the set of rules 218 in a state transition matrix on the blockchain 206, such as the rules matrix 400 depicted in FIG. 4. The rules matrix 400 correlates the rules 214 in the set of rules 218 to a respective transition of the workflow instance 212 from initial states to final states.

According to examples, the rules matrix 400 includes columns 402, which represent the initial states of state transitions, and rows 404, which represent the final states of the state transitions. A cell in the rules matrix 400 includes a rule correlated to a respective initial state and final state of the workflow instance 212. For instance, the rule 214 “R₁₋₂” is a rule to transition from the first state 302-1 of the workflow instance 212 to the second state 302-2, the rule 214 “R₂₋₄” is a rule to transition from the second state 302-2 to a fourth state 302-4, and so on. A cell that does not include a rule 214 is represented in the rules matrix 400 with a “-” symbol. The processor 102 is to determine that a transaction 208 that is correlated with a cell represented by the “-” symbol is an invalid transaction.

By way of particular example and for purposes of illustration, the smart contract 210 is to control transfer of tokens between different accounts based on received transactions 208. In this particular example, the received transaction 208 is to send 10 tokens from a first account at a first state 302-1 to a second account at a second state 302-2. The rule 214 R₁₋₂ includes a condition to be satisfied before allowing the transfer of tokens from the first state 302-1 to the second state 302-2. In this particular example, the rule 214 R₁₋₂ includes a condition, for instance, that the tokens is transferred only on “Mondays.” Various aspects of the present disclosure is described hereinafter using on this particular example of a smart contract to transfer tokens. It should be understood, however, that the present disclosure is not limited to this type of smart contract nor such transactions for transferring tokens, and various different types and complexity of smart contracts are applicable to the present disclosure.

The processor 102 is to execute the operation 112 to identify the rule 214 correlated to the received transaction 208 among the set of rules 218 for the smart contract 210. In some examples, the processor 102 is to access the rules matrix 400 to identify a rule 214 that correlates to the received transaction 208. Continuing with the particular example above in which the smart contract 210 is to transfer tokens, the processor 102 is to access the rules matrix 400 to identify the rule 214 R₁₋₂ correlated with a transition from the first state 302-1 to the second state 302-2.

The processor 102 is to execute the operation 114 to load the identified rule 214 R₁₋₂ correlated to the received transaction 208 into the smart contract 210. In some examples, the processor 102 is to load a certain rule 214 correlated to a transaction 208 each time a transaction 208 is received. In some examples, the processor 102 is to load all of the rules 214 for all of the states 302, for instance, all of the rules 214 in the set of rules 218 for the workflow instance 212.

The processor 102 is to execute the operation 116 to determine whether the received transaction 208 is valid based on application of the identified rule 214 in the smart contract 210. In some examples, the identified rule 214 is a function which takes the transaction 208 as an argument. Continuing with the particular example, the processor 102 applies the rule 214 R₁₋₂ to determine whether the day associated with the transaction 208 is a “Monday.” In case the day associated with the received transaction 208 is a “Monday,” the processor 102 is to determine whether the received transaction 208 is valid. Otherwise, in case the day associated with the received transaction 208 is not a “Monday,” the processor 102 is to determine that the received transaction 208 is not valid and to block the received transaction 208.

The processor 102 is to execute the operation 118 to progress the state 302 of the workflow instance 212 of the smart contract 210 based on a determination that the received transaction 208 is valid via application of the identified rule 214. Continuing with the particular example, based on a determination that the day associated with the received transaction 208 is a “Monday,” the processor 102 advances the state of the workflow instance 212 from the first state 302-1 to the 302-2. In case the received transaction 208 is valid, the processor 102 executes operations to perform the transfer of the 10 tokens from the first account in the first state 302-1 to the second account in the second state 302-2, including updating the balances of the sender and the receiver accounts, or other types of appropriate functions. The instructions, or code, to perform the fund transfer is stored as part of the smart contract 210. Otherwise, in case the day associated with the received transaction 208 is not a “Monday,” the processor 102 determines that the received transaction 208 is not valid, and prevents progress of the state of the workflow instance 212 from the first state 302-1.

In some examples, the processor 102 is to receive a blockchain transaction to create or delete a workflow instance 212. For instance, the processor 102 is to deploy the smart contract 210 on the blockchain 206. The processor 102 is to create an initial set of rules for the smart contract 210 in the blockchain 206, such as the set of rules 218 stored in the rules matrix 400 depicted in FIG. 4. In some examples, the processor 102 is to create the initial set of rules for the smart contract 210 based on a received transaction 208 to create the initial set of rules. The processor 102 is to store the set of rules 218 on the blockchain separate from the smart contract 210. Based on a blockchain transaction to create a workflow instance for the smart contract 210, the processor 102 is to create the workflow instance 212 based on the initial set of rules 218 stored in the rules matrix 400. The processor 102 is to delete the workflow instance 212 based on a blockchain transaction to delete the workflow instance 212.

In some examples, the processor 102 is to receive a blockchain transaction to modify the workflow instance 212. In some examples, the processor 102 is to receive a transaction 208 to modify the set of rules 218 for the smart contract 210 on the blockchain 206. The smart contract 210 includes instructions, such as code, to execute operations to modify the set of rules 218.

Referring to FIG. 5A, the processor 102 is to store modified versions of the set of rules 218 on the blockchain 206. In some examples, the modified versions of the set of rules 218 are stored as the modified set of rules 220-1 to 220-n. In some examples, the modified set of rules 220-1 to 220-n are modifications of a previously modified set of rules 220-1 to 220-n. The processor 102 is to store the modified set of rules 220-1 to 220-n separate from the smart contract 210 on the blockchain 206. In some examples, the modified set of rules 220-1 to 220-n are stored as rules matrixes, such as the modified rules matrixes 502-1 to 502-p.

The processor 102 is to update a rule 214 in the rules matrix 400 for the workflow instance 212, and store the updated version as a modified rules matrix 502-1 to 502-p to replace the rules matrix 400. Alternatively, the processor 102 is to create a new modified version based on the rules matrix 400 or another modified rules matrix 502-1 to 502-p, and store the new modified rules matrix as a second version together with the unmodified version of the rules matrix 400. It should be understood that a plurality of modified set of rules 220-1 to 220-n may be stored on the blockchain 206. In some examples, the plurality of modified set of rules 220-1 to 220-n are stored as rules matrixes, such as the modified rules matrixes 502-1 to 502-p. The modified rules matrixes 502-1 to 502-p are modifications based on the rules matrix 400, a previously modified rules matrixes 502-1 to 502-p, or a combination thereof.

In some examples, the modified rules matrixes 502-1 to 502-p are stored in an array, which is extended at any time based on additional modifications to the rules 214. In some examples, the array includes the original rules matrix 400. The newly added versions of the modified rules matrixes 502-1 to 502-p is a modification based on the original rules matrix 400, the previously modified rules matrixes 502-1 to 502-p, or a combination thereof. The processor 102 is to access any of the original rules matrix 400 or the modified rules matrixes 502-1 to 502-p in the array.

Based on the transaction 208 to modify the set of rules 218, the processor 102 is to update a condition of a certain rule 214 of the set of rules 218, delete a certain rule 214 of the set of rules 218, add a certain rule 214 of the set of rules 218, or a combination thereof. By way of particular example and for purposes of illustration, the processor 102 receives the transaction 208 to delete the fourth state 302-4. The processor 102 deletes the rule 214 R₂₋₄ correlated to a transition from the second state 302-2 to the fourth state 302-4 and the rule 214 R₃₋₄ correlated to a transition from the third state 302-3 to the fourth state 302-4 in the rules matrix 400. The processor 102 adds the rule 504 R₂₋₅ in the modified rules matrix 502-1 to 502-p correlated to a transition from the second state 302-2 to the fifth state 302-5, thus bypassing the fourth state 302-4. Likewise, the processor 102 adds the rule 506 R₃₋₅ in the modified rules matrix 502-1 to 502-p correlated to a transition from the third state 302-3 to the fifth state 302-5.

In some examples, the processor 102 is to apply version control for multiple versions of the rules matrixes 502-1 to 502-p to ensure compatibility for multiple versions. For instance, the processor 102 is to correlate new workflow instances, such as the modified workflow instance 508, to the modified rules matrixes 502-1 to 502-p. In these instances, the processor 102 is to apply the modified rules matrixes 502-1 to 502-p for subsequent workflow instances.

The processor 102 is to correlate any existing workflow instances, such as the workflow instance 212, to the rules matrix 400. Continuing with the above example in which the fourth state 302-4 is deleted, after deployment of the modified workflow instance 508, the processor 102 processes transactions 208 for in-progress workflows instances, such as the workflow instance 212, which is be unmodified. In this case, a transaction 208 at the fourth state 302-4, which does not exist in the new modified workflow instance 508, is allowed to progress and is not blocked because the first version of the rules matrix 400 for the workflow instance 212 is applied to the transaction 208.

Referring to FIG. 5B, the processor 102 is to receive a blockchain transaction to add a state 302 to the workflow instance 212. For instance, the processor 102 is to create a modified rules matrix 510-1 correlated to a modified workflow instance 512. The processor 102 is to extend the rules matrix 400 to add a row 514 and a column 516. The processor 102 is to add a new rule 518 R₅₋₆, which is correlated to a state transition from the fifth state 302-5 to a new sixth state 302-6. The processor 102 is to instantiate the new sixth state 302-6 based on receipt of subsequent transactions that are correlated to a transition from the fifth state 302-5 to the sixth state 302-6. In some examples, the processor 102 is to modify the rules matrix 400 to create the modified rules matrix 510-1, which replaces the rules matrix 400 or is stored as another version together with the rules matrix 400.

In some examples, a plurality of modified rules matrixes 510-1 to 510-q are stored on the blockchain 206. The processor 102 is to access any of the plurality of versions of the modified rules matrixes 510-1 to 510-q based on a received transaction 208. In some examples, the plurality of modified rules matrixes 510-1 to 510-q are modifications based on the rules matrix 400, any of the previously modified rules matrixes 510-1 to 510-q, or a combination thereof. In some examples, the plurality of modified rules matrixes 510-1 to 510-q are stored in an array. In some examples, the array includes other rules matrixes, such as the original rules matrix 400 or the modified rules matrixes 502-1 to 502-p. The processor 102 is able to access any of the matrixes store in the array at any time based on a received transaction 208.

Referring to FIG. 6, the processor 102 is to apply a version bridge process to bridge states 302 between different versions of workflow instances. A plurality of bridge rules matrixes 222-1 to 222-m are to allow transition of in-progress workflow instances to new rules in new workflow instances, while avoiding potential compatibility issues. For instance, the processor 102 is to bridge a state 302 in an unmodified workflow instance, such as the workflow instance 212, to a modified workflow instance, such as the modified workflow instance 508, by applying the bridge rules matrix 222-1. In some examples, the workflow instance 212 is based on the unmodified version of the set of rules 218, and the modified workflow instance 508 is based on the modified version of the set of rules 220-1.

By way of particular example, in the modified workflow instance 508, the fourth state 302-4 is deleted, and thus the state of the smart contract 210 is to progress directly from the second state 302-2 to the fifth state 302-5. Based on creation of the modified version of the set of rules 220-1, the processor 102 creates another set of rules, such as the bridge rules matrix 222-1, for the smart contract 210 to bridge the modified version of the set of rules 220-1 to the unmodified version of the set of rules 218. Based on the bridge rules matrix 222-1, the processor 102 progresses the state 302 of prior versions of workflow instances, such as the workflow instance 212, from the fourth state 302-4, which is correlated to the unmodified version of the set of rules 218, to a fifth state 302-5, which is correlated to the modified version of the set of rules 220-1.

In this particular example, the bridge rules matrix 222-1 includes a bridge rule 602 R′₄₋₅, which is correlated to a jump from the fourth state 302-4 in the workflow instance 212 to the fifth state 302-5 in the modified workflow instance 508. Based on the received transaction 208 at the workflow instance 212, the processor 102 retrieves the bridge rule 602 R′₄₋₅ from the bridge rules matrix 222-1, and loads the bridge rule 602 R′₄₋₅ to the smart contract 210. The processor 102 applies the bridge rule 602 R′₄₋₅ to transition a state of the workflow instance 212 to jump from the fourth state 302-4 in the workflow instance 212 to the fifth state 302-5 in the modified workflow instance 508. In some examples, a plurality of bridge rules matrixes 222-1 to 222-m are stored on the blockchain 206, which provides a bridge between various versions of workflow instances or rules matrixes. In some examples, a bridge rules matrix 222-1 to 222-m is a bridge between a plurality of versions of rules matrixes, including the rules matrix 400, any of the modified rules matrix 502-1 to 502-p, 510-1 to 510-q, or a combination thereof. In some examples, the plurality of bridge rules matrixes 222-1 to 222-m are stored in an array. The processor 102 is able to access any of the plurality of bridge rules matrixes 222-1 to 222-m in the array.

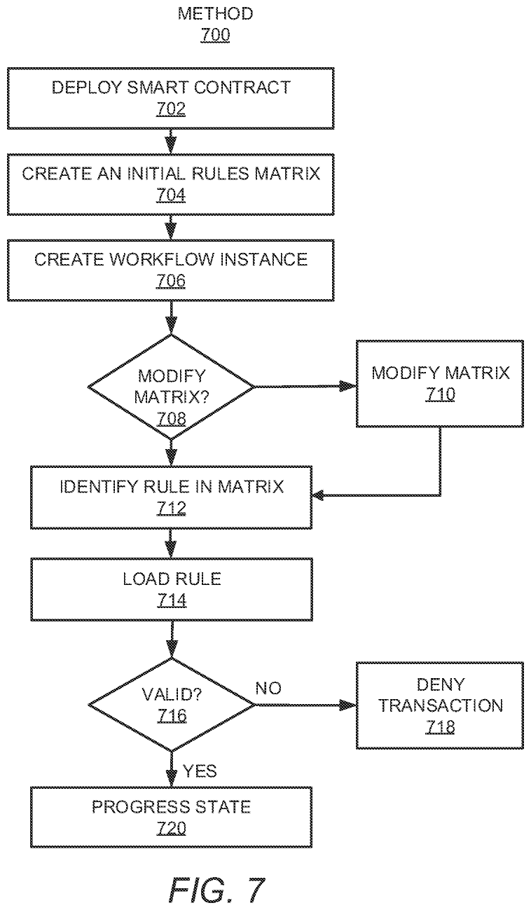

Various manners in which the processor 102 is to operate are discussed in greater detail with respect to the method 700 depicted in FIG. 7. Particularly, FIG. 7 depicts a flow diagram of a method 700 for deploying a smart contract, creating an initial rules matrix, modifying the rules matrix, and loading a rule from the initial rules matrix or the modified rules matrix to progress a state of the smart contract. It should be understood that the method 700 depicted in FIG. 7 may include additional operations and that some of the operations described therein may be removed or modified without departing from the scopes of the method 700. The description of the method 700 is made with reference to the features depicted in FIGS. 1-6 for purposes of illustration.

At block 702, the processor 102 deploys a smart contract 210 in a blockchain 206. The smart contract 210 includes instructions, or code, to transition a state of a workflow of the smart contract 210. The smart contract 210 is stored on the blockchain 206 separately from a set of rules 218 correlated with the smart contract 210.

At block 704, the processor 102 creates an initial rules matrix for the smart contract 210, such as the rules matrix 400 depicted in FIG. 4. In some examples, the processor 102 creates the rules matrix 400 based on a transaction 208 to create the rules matrix 400. The rules matrix 400 includes the set of rules 218. The rules matrix 400 is stored on the blockchain 206 separate from the smart contract 210.

At block 706, the processor 102 creates a workflow instance 212 on the blockchain based on the rules matrix 400. In some examples, the workflow instance 212 includes a plurality of states 302. The plurality of states 302 are correlated to certain rules 214 in the rules matrix 400.

At block 708, the processor 102 determines whether to modify the rules matrix 400 based on a received transaction 208 to modify the set of rules 218. In some examples, the processor 102 modifies one or more than one rule 214 in the rules matrix 400 based on the received blockchain transaction.

At block 710, based on a determination to modify the rules matrix 400, the processor 102 creates a modified rules matrix, such as the modified rules matrixes 502-1 to 502-p and 510-1 to 510-q depicted in FIGS. 5A and 5B.

At block 712, the processor 102 identifies a rule 214 correlated to a received transaction 208 to progress a state of the workflow instance 212. The processor 102 identifies the rule 214 from the rules matrix 400 or the modified rules matrixes 502-1 to 502-p and 510-1 to 510-q.

At block 714, the processor 102 loads the identified rule 214 into the smart contract 210. The identified rule 214 defines a condition to be satisfied prior to allowing the transaction 208 and transitioning the state of the workflow instance 212.

At block 716, the processor 102 applies the rule 214 to the received transaction 208 to determine whether the transaction 208 is valid. At block 718, based on a determination that the transaction 208 is invalid, the processor 102 denies the transaction 208.

At block 720, based on a determination that the transaction 208 is valid, the processor 102 allows the transaction 208. The processor 102 executes operations to perform the transaction 208 and progresses the state of the workflow instance 212.

Some or all of the operations set forth in the method 700 are included as utilities, programs, or subprograms, in any desired computer accessible medium. In addition, the method 700 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

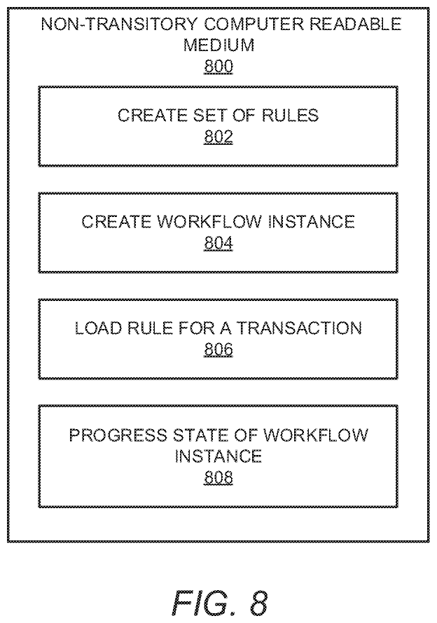

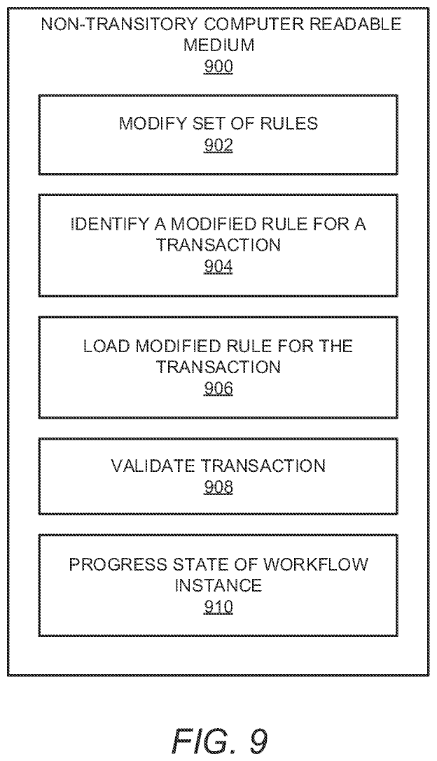

Reference is now made to FIGS. 8 and 9. FIG. 8 depicts a block diagram of an example non-transitory computer-readable medium 800 that has stored thereon computer-readable instructions to create a set of rules 218 for a smart contract 210 and to load a rule 214 for a transaction 208 from the set of rules 218 to progress a state of a workflow instance 212 of the smart contract 210. FIG. 9 depicts a block diagram of an example non-transitory computer-readable medium 900 that has stored thereon computer-readable instructions to modify a set of rules 218 for a smart contract 210 and to load a modified rule 214 for a transaction 208 from the modified set of rules 220-1 to progress a state of a workflow instance 212 of the smart contract 210. It should be understood that the computer-readable medium 800 and 900 depicted in FIGS. 8 and 9 may include additional instructions and that some of the instructions described herein may be removed or modified without departing from the scope of the computer-readable medium 800 and 900 disclosed herein. The computer-readable medium 800 and 900 may be a non-transitory computer readable medium. The term “non-transitory” does not encompass transitory propagating signals.

The computer-readable medium 800 has stored thereon machine readable instructions 802-808 that a processor, such as the processor 102 depicted in FIGS. 1 and 2, is to execute. The computer readable medium 800 is an electronic, magnetic, optical, or other physical storage device that contains or stores executable instructions. The computer readable medium 800 is, for example, Random Access memory (RAM), an Electrically Erasable Programmable Read-Only Memory (EEPROM), a storage device, an optical disc, and the like.

The processor is to fetch, decode, and execute the instructions 802 to create a set of rules 218 for the smart contract 210 based on a first transaction, such as the transaction 208 depicted in FIG. 2. The processor is to store the set of rules 218 on a blockchain 206. The processor is to store the set of rules 218 separate from the smart contract 210 on the blockchain 206.

The processor is to fetch, decode, and execute the instructions 804 to create a workflow instance 212 for the smart contract 210 on the blockchain 206 based on a second transaction, such as the transaction 208. The workflow instance 212 includes a plurality of states, which is defined based on the set of rules 218.

The processor is to fetch, decode, and execute the instructions 806 to load a rule 214 from the set of rules 218 into the smart contract 210 based on a third transaction, such as the transaction 208, to progress a state of the workflow instance 212 of the smart contract 210. The loaded rule 214 is correlated to a state of the workflow instance 212.

The processor is to fetch, decode, and execute the instructions 808 to progress the state of the workflow instance 212 based on a verification of the third transaction via application of the loaded rule 214 in the smart contract 210.

According to examples, the processor is to modify the set of rules 218 for the smart contract 210. The processor is to store the modified set of rules 220-1 to 220-n, separate from the smart contract 210, on the blockchain 206.

According to examples, based on a fourth transaction to modify the set of rules 218 for the smart contract 210, the processor is to create a modified version of the set of rules 218, such as the modified rules matrixes 502-1 to 502-p and 510-1 to 510-q depicted in FIGS. 5A and 5B. The processor is to store the modified rules matrixes 502-1 to 502-p, together with an unmodified version of the set of rules, such as the rules matrix 400, on the blockchain 106. By way of particular example, the processor is to apply the unmodified version of the set of rules 218 for the workflow instance 212, for instance pre-existing workflow instances prior to creation of the modified rules matrix 502-1. The processor is to apply the modified rules matrix 502-1 for subsequent workflow instances, such as the modified workflow instance 512, created after creation of the modified rules matrix 502-1.

According to examples, based on creation of the modified rules matrix 502-1 to 502-p and 510-1 to 510-q, the processor is to create a second set of rules, such as the bridge rules matrix 222-1 to 222-m depicted in FIGS. 2 and 6, for the smart contract 210 to bridge between the modified rules matrix 502-1 to 502-p and 510-1 to 510-q and the unmodified version of the set of rules 218. Based on the bridge rules matrixes 222-1 to 222-m for the smart contract 210, the processor is to progress the state of the workflow instance 212 of the smart contract 210 from a first state, which is correlated to the unmodified version of the set of rules 218, to a second state, which is correlated to the modified rules matrixes 502-1 to 502-p and 510-1 to 510-q.

The computer-readable medium 900 has stored thereon machine-readable instructions 902-910 that a processor, such as the processor 102 depicted in FIGS. 1 and 2, is to execute. The computer-readable medium 900 is an electronic, magnetic, optical, or other physical storage device that contains or stores executable instructions. The computer readable medium 800 is, for example, Random Access memory (RAM), an Electrically Erasable Programmable Read-Only Memory (EEPROM), a storage device, an optical disc, and the like.

The processor is to fetch, decode, and execute the instructions 902 to modify a set of rules 218 for an application program on a blockchain based on a first transaction, such as the transaction 208 depicted in FIG. 2. The application program is to include instructions, or code, to perform various functions based on transactions on the blockchain. In some examples, the application program is the same as the smart contract 210 depicted in FIG. 2. The processor is to store the modified set of rules 220-1 to 220-n on the blockchain 206 separate from the application program.

The processor is to fetch, decode, and execute the instructions 904 to identify a modified rule, such as the rule 214 depicted in FIG. 2, based on a second transaction to progress a state of a workflow instance 212 of the application program. In some examples, the second transaction is the same as the transaction 208. The processor is to identify the modified rule 214 correlated to the second transaction among the modified set of rules 220-1 to 220-n for the application program.

The processor is to fetch, decode, and execute the instructions 906 to load the modified rule 214 correlated to the second transaction among the modified set of rules 220-1 to 220-n into the application program.

The processor is to fetch, decode, and execute the instructions 908 to determine whether the second transaction is valid based on application of the modified rule 214 in the application program.

The processor is to fetch, decode, and execute the instructions 910 to progress the state of the workflow instance 212 of the application program based on a determination that the second transaction is valid based on application of the modified rule.

According to examples, the processor is to create a modified version of the set of rules to be stored, such as the modified rules matrixes 502-1 to 502-p and 510-1 to 510-q depicted in FIGS. 5A and 5B. The processor is to store the modified version of the set of rules together with an unmodified version of the set of rules, such as the rules matrix 400, on the blockchain 206. The processor is to apply the unmodified version of the set of rules for the workflow instance 212, and apply the modified version of the set of rules for subsequent workflow instances, such as the modified workflow instance 508 depicted in FIG. 5A, created after creation of the modified version of the set of rules.

According to examples, the processor is to create, based on creation of the modified version of the set of rules, a second set of rules for the application program to bridge the modified version of the set of rules to the unmodified version of the set of rules. In some examples, the second set of rules is the same as the bridge rules matrix 222-1 to 222-m depicted in FIGS. 2 and 6. Based on the second set of rules for the application program, the processor is to progress the state of the workflow instance of the application program from a first state, which is correlated to the unmodified version of the set of rules, to a second state, which is correlated to the modified version of the set of rules.

What is claimed is:

1. An apparatus comprising:
a processor to:
receive a transaction for a smart contract on a blockchain, the received transaction to progress a state of a workflow instance of the smart contract;
identify a rule correlated to the received transaction among a set of rules for the smart contract;
load the identified rule correlated to the received transaction into the smart contract;
determine whether the received transaction is valid based on application of the identified rule in the smart contract; and
based on a determination that the received transaction is valid based on application of the identified rule, progress the state of the workflow instance of the smart contract.

2. The apparatus of claim 1, wherein the processor is to:
store the set of rules for the smart contract on the blockchain, separate from the smart contract.

3. The apparatus of claim 1, wherein the processor is to:
store the set of rules in a state transition matrix on the blockchain, the state transition matrix to correlate the identified rule of the set of rules to a transition of the state of the workflow instance from a first state to a second state.

4. The apparatus of claim 1, wherein the processor is to:
receive a second transaction to modify the set of rules for the smart contract; and
based on the second transaction, store a modified version of the set of rules on the blockchain, the modified version of the set of rules to be stored separate from the smart contract.

5. The apparatus of claim 4, wherein, based on the second transaction to modify the set of rules, the processor is to update a condition of a certain rule of the set of rules, delete a certain rule of the set of rules, add a certain rule of the set of rules, or a combination thereof.

6. The apparatus of claim 1, wherein the processor is to:
receive a second transaction to modify the set of rules for the smart contract;
based on the second transaction, create a modified version of the set of rules; and
store the modified version of the set of rules together with an unmodified version of the set of rules on the blockchain.

7. The apparatus of claim 6, wherein the processor is to:
apply the unmodified version of the set of rules for the workflow instance; and
apply the modified version of the set of rules for subsequent workflow instances created after creation of the modified version of the set of rules.

8. The apparatus of claim 6, wherein the processor is to:
based on creation of the modified version of the set of rules, create a second set of rules for the smart contract to bridge the modified version of the set of rules to the unmodified version of the set of rules; and
based on the second set of rules for the smart contract, progress the state of the workflow instance of the smart contract from a first state, which is correlated to the unmodified version of the set of rules, to a second state, which is correlated to the modified version of the set of rules.

9. A non-transitory computer-readable medium on which is stored machine readable instructions that when executed by a processor, cause the processor to:
based on a first transaction, create a set of rules for a smart contract, the set of rules to be stored on a blockchain separate from the smart contract;
based on a second transaction, create a workflow instance for the smart contract on the blockchain;
based on a third transaction, load a rule from the set of rules into the smart contract, the loaded rule to be correlated to a state of the workflow instance; and
progress the state of the workflow instance based on a verification of the third transaction via application of the loaded rule in the smart contract.

10. The non-transitory computer-readable medium of claim 9, wherein the instructions are further to cause the processor to:
modify the set of rules for the smart contract; and
store the modified set of rules, separate from the smart contract, on the blockchain.

11. The non-transitory computer-readable medium of claim 9, wherein the instructions are further to cause the processor to:
based on a fourth transaction to modify the set of rules for the smart contract, create a modified version of the set of rules;
store the modified version of the set of rules, together with an unmodified version of the set of rules, on the blockchain;
apply the unmodified version of the set of rules for the workflow instance; and
apply the modified version of the set of rules for subsequent workflow instances created after creation of the modified version of the set of rules.

12. The non-transitory computer-readable medium of claim 11, wherein the instructions are further to cause the processor to:
based on creation of the modified version of the set of rules, create a second set of rules for the smart contract to bridge between the modified version of the set of rules and the unmodified version of the set of rules; and
based on the second set of rules for the smart contract, progress the state of the workflow instance of the smart contract from a first state, which is correlated to the unmodified version of the set of rules, to a second state, which is correlated to the modified version of the set of rules.

13. A non-transitory computer-readable medium on which is stored machine readable instructions that when executed by a processor, cause the processor to:
based on a first transaction, modify a set of rules for an application program on a blockchain, the modified set of rules being stored on the blockchain separate from the application program;
based on a second transaction to progress a state of a workflow instance of the application program, identify a modified rule correlated to the second transaction among the modified set of rules for the application program;
load the modified rule correlated to the second transaction among the modified set of rules into the application program;
determine whether the second transaction is valid based on application of the modified rule in the application program; and
based on a determination that the second transaction is valid based on application of the modified rule, progress the state of the workflow instance of the application program.

14. The non-transitory computer-readable medium of claim 13, wherein the instructions are further to cause the processor to:
based on the first transaction to modify the set of rules for the application program, create a modified version of the set of rules to be stored, together with an unmodified version of the set of rules, on the blockchain;
apply the unmodified version of the set of rules for the workflow instance; and
apply the modified version of the set of rules for subsequent workflow instances created after creation of the modified version of the set of rules.

15. The non-transitory computer-readable medium of claim 14, wherein the instructions are further to cause the processor to:
based on creation of the modified version of the set of rules, create a second set of rules for the application program to bridge the modified version of the set of rules to the unmodified version of the set of rules; and
based on the second set of rules for the application program, progress the state of the workflow instance of the application program from a first state, which is correlated to the unmodified version of the set of rules, to a second state, which is correlated to the modified version of the set of rules.
